(19) United States
(12) Patent Application Publication
(10) Pub. No.: US 2017/0024547 A1
(43) Pub. Date: Jan. 26, 2017

(54) System and Method for Obtaining Electronic Remote Informed Consent

(71) Applicant: Sachin Bidani, Hallandale Beach, FL (US)

(72) Inventor: Sachin Bidani, Hallandale Beach, FL (US)

(21) Appl. No.: 15/078,641

(22) Filed: Mar. 23, 2016

Related U.S. Application Data
(60) Provisional application No. 62/196,756, filed on Jul. 24, 2015.

(51) Int. Cl. G06F 19/00; G06F 3/0484; G06F 17/30; G06F 17/24

(52) U.S. Cl. CPC G06F 19/363; G06F 19/324; G06F 17/243; G06F 3/0484; G06F 17/30554

(57) ABSTRACT

Systems and methods for obtaining an electronic informed consent from a patient/trial subject for a medical procedure/clinical trial recruitment. A search query may be received from the patient/trial subject. After transmitting a search result, a registration request may be received from the patient/trial subject to participate in one or more medical procedure/clinical trial. At least one unique code is transmitted to the patient/trial subject. Each code may be specific to the medical practitioner conducting the medical procedure/clinical trial. The code enables the patient/trial subject to access a multimedia file corresponding to the medical practitioner. Input on the multimedia file is received and informed consent is invoked in response to receipt of the input. An electronic consent on an informed consent form is then received.

This application claims the benefit of U.S. Provisional Application Ser. No. 62/196,756, filed on Jul. 24, 2015, which is expressly incorporated by reference herein.

### TECHNICAL FIELD

The present invention generally relates to server and methods for obtaining electronic informed consent from a patient/trial subject for medical procedures/clinical trial recruitments. More particularly, the present invention relates to server and methods for obtaining informed consent remotely i.e. the patient/trial subjects are not required to visit the hospitals/medical personnel/clinical trial institutes.

### BACKGROUND

Most of the patients/trial subjects, generally, are not aware of the complexities involved in medical procedures/clinical trials. Documenting such complexities in densely worded documents does not help the patients/trial subjects, as most of the patients/trial subjects are not able to understand or even grasp the intricacies of medical procedures/clinical trials such as treatment options and risks involved in said medical procedures/clinical trials. As a result, patients/trial subjects do not feel involved in their own medical care. In addition, due to lack of understanding of said medical procedures/clinical trials, the patients/trial subjects are not able to comply with the instructions needed to perform, prepare and recover from said medical procedure/clinical trial, which may result into negative outcomes.

Such negative outcomes, apart from being detrimental to the health of patient/trial subject, also affect the hospitals/medical personnel/clinical trial institutes involved in such medical procedures/clinical trials. For example, a patient/trial subject may file costly malpractice suits against such doctors/hospitals/institutions. Owing to such suits, the other patients/trial subjects may not feel comfortable to enroll with such hospitals/medical personnel/clinical trial institutes for clinical trials/medical procedures.

Most of the prior art discloses servers and methods for obtaining informed consent from the patient/trial subject that requires the patient/trial subject to visit the doctors/hospitals/clinical trial institutes for understanding the treatment options, risks involved and outcomes of medical procedures/clinical trials which can be difficult, time consuming and inconvenient to the patients/trial subjects. Prior art documents also disclose servers and methods for transmitting information in relation to medical procedures/clinical trials over the internet. However, such information is not specific to the medical practitioner conducting the medical procedure/clinical trial. In addition, the patient/trial subjects are also not sure whom to contact in case of any doubts/queries. As a result, the patient/trial subjects are hesitant to (i) enroll in such medical procedure/clinical trials and (ii) share their personal details over the internet unless they are confident about the medical practitioner conducting the clinical trials. As a result, online participation of patient/trial subjects in medical procedures/clinical trials is limited.

Keeping in view the above, there is an unmet need for improved methods and server implementing said methods, which are safe, interactive, clearly explains the details of medical procedures remotely i.e. without visiting the doctors/hospitals/medical institutes, facilitates round the clock communication with the medical practitioner and/or medical representative in case of doubt/queries, increases online participation of patient/trial subjects in medical procedures/clinical trials.

### OBJECTS OF THE INVENTION

Apart from overcoming the disadvantages discussed above, a primary object of the present invention is to provide a server and methods wherein the patient/trial subject does not have to visit the hospital/medical personnel/clinical trial institute for receiving information related to medical procedure/clinical trial. The information may be presented to the patient/trial subject remotely i.e. without visiting the hospital/medical personnel/clinical trial institute via an interactive multi-media file including texts, graphics, audio, video, podcasts, interactive websites/links or any combination thereof.

Another object of the present invention is to provide server and methods wherein the patients/trial subjects can understand/clarify/discuss treatment options, risks involved and outcomes of the medical procedure/clinical trials with a medical practitioner and/or qualified employees/medical representatives of a central informed consent unit (CICU) remotely i.e., without visiting the hospital/medical personnel/clinical trial institute. The same can be accomplished by selecting, in an interactive multimedia file, options that invoke communication channels with the medical practitioner and/or medical representatives of CICU. The multimedia file may, alternatively, be provided with contact information, which can be used by the patient/trial subject to contact the medical practitioner and/or medical representative. Communication may be established using means known in the prior art including electronic messaging, telephone calls, videoconferencing, online/offline chat or any combination thereof.

Yet another object of the present invention is to provide a server and methods that receives consent from the patient/trial subject on an informed consent form remotely i.e. without visiting the hospital/medical personal/clinical trial institutes. The said informed consent form can be invoked by selecting a selectable option on said multimedia file. The said consent is given by signing the informed consent document via electronic means including video, audio, photo, digital signature, biometrics or any combination thereof.

Yet another object of the present invention is to provide server and methods wherein all the trials conducted by medical professionals/clinical trial institutes are available on a website/mobile application hosted by the server. Patients/trial subjects can enter a search query based on one or more parameters including location of clinical trials, duration of clinical trials, disease/medical conditions and name of a medical practitioner conducting the medical procedure/clinical trial. The server and method of the present invention transmits a search result to the patient/trial subject based on the selected parameters.

Yet another object of the present invention is to provide server and methods that maintains confidentiality of a patient/trial subject. The patient/trial subject, on registration with the server of the present invention, receives a unique code. The said unique code is specific to a medical practitioner and only said medical practitioner will get access to the information shared by the patient/trial subject. Further, on completion of the consent process on the informed consent form, a copy of said consent form is transmitted only to the patient/trial subject and the medical practitioner to ensure the confidentiality of the patient/trial subject.

Yet another object of the present invention is to provide server and methods wherein the patient/trial subject can immediately withdraw from the clinical trials/medical procedures.

Yet another object of the present invention is to provide server and methods for improved compliance of patients/trial subjects to medical procedures/clinical trials.

Yet another object of the present invention is to provide servers and method wherein patient/trial subject shall be automatically updated on any changes made to the informed consent form.

Yet another object of the present invention is to provide server and methods wherein any change to the informed consent form shall require the complete process of approval and signing by the patient/trial subject.

Yet another object of the present invention is to provide a central informed consent unit. The CICU unit has one or more qualified employee/medical representatives for resolution of patient/trial subject queries round the clock. The medical representatives of CICU communicate with the patient/trial subject.

Yet another object of the present invention is to provide a server and methods wherein online subject enrolment and participation in clinical trials/medical procedures can be facilitated.

Yet another object of the present invention is to bring in more transparency and involvement of patient/trial subjects in medical procedures/clinical trials.

Yet another object of the present invention is to provide server and methods which are safe, interactive, clearly explains the treatment procedures remotely i.e. without visiting the doctors/hospitals/medical institutes, facilitates round the clock communication with the medical practitioner and/or qualified employees/medical representative in case of doubt/queries, increases online participation of patient/trial subjects in medical procedures/clinical trials.

### SUMMARY OF THE INVENTION

In accordance with the purposes of the invention, the present invention as embodied and broadly described herein, provides server and methods for obtaining informed consent from a patient/trial subject remotely i.e. without visiting the hospital/medical personal/clinical trial institutes.

According to one aspect of the invention, a website/mobile application hosted by the server displays information in relation to medical procedure/clinical trials. The information relates to location of clinical trials, duration of clinical trials, medical practitioners conducting the clinical trials, diseases/medical conditions for which clinical trials are being conducted. A client may visit the website or download the mobile application. The client uploads a draft document along with an informed consent form on the server using said website/mobile application. The draft document comprises details of medical procedure including treatment options, risks involved outcomes of said medical procedures/clinical trials.

According to another aspect of the invention, the documents uploaded by the client are assigned to a team. The said team (i) prepare dialogue transcripts (ii) translate and back translate said dialogue transcripts along with the informed consent form from one language to another language and (iii) assigns versions to documents mentioned in (i) and (ii). The said team, thereafter, uploads the documents on the server, which is retrieved by the client for approval. The team, on receiving approval from the client, prepares an interactive multimedia file and uploads it on the server. The said multi-media file, apart from the details of the medical procedure/clinical trial, also includes details of a medical practitioner assigned for conducting said clinical trial/medical procedure and site/location information at which the medical procedure/clinical trial is being conducted. Every medical practitioner is given a unique code by the server.

According to yet another aspect of the invention, a patient/trial subject visits the website or downloads the mobile application hosted by the server. The patient/trial subject submits a search query relating to one or more of (i) location of clinical trials, (ii) duration of clinical trials, (iii) medical condition/disease for which the trial is being conducted and (iv) medical representative conducting said clinical trials and receives search results. The patient/trial subject may submit a request for registration for participating in a medical procedure/clinical trial.

According to yet another aspect of the invention, a patient/trial subject, on registration, receives unique code of the medical practitioner conducting said medical procedure/clinical trial.

According to yet another aspect of the invention, the patient/trial subject accesses the multimedia file using the unique code. The patient/trial subject can, thereafter, initiate communication with the medical practitioner or qualified employees/medical representatives of Central Informed Consent Unit (CICU) to understand the medical procedure/clinical trial, invoke an informed consent form by selecting a selectable option on said multi-media file, provide an informed consent on said informed consent form or withdraw from the medical procedure/clinical trial. The said informed consent is obtained on the informed consent form via electronic means including video, audio, photo, digital signatures, biometrics or any combination thereof.

According to yet another aspect of the invention, the medical practitioner may receive details of registered patient/trial subjects from the server. The medical practitioner selects one or more patient/trial subject for medical procedures/clinical trials. The server transmits the unique code of the medical practitioner to the selected patient/trial subject. The patient/trial subject uses the unique code to access the interactive multimedia file.

According to yet another aspect of the invention, the patient/trial subject can communicate with the medical practitioner. In the absence of medical practitioner, the patient/trial subject may interact with qualified employees/medical representatives of a Central Informed Consent Unit (CICU). The qualified employee/medical representatives of CICU are available for resolution of patient queries round the clock. The qualified employees/medical representatives of CICU may communicate with the patient/trial subject via means known in the art including, electronic messaging, telephone calls, videoconferencing, online/offline chat or any combination thereof.

According to yet another aspect of the invention, the patient/trial subject can remotely interact with physician/investigator at any time before and after the enrolment or registration in a medical procedure/clinical trial. Such interactions may be performed by invoking communication means in the multimedia file. The said communication means include means such as electronic messaging, telephone calls, videoconferencing, online/offline chat or any combination thereof.

These and other aspects as well as advantages will be more clearly understood from the following detailed description taken in conjugation with the accompanying drawings.

### BRIEF DESCRIPTION OF THE ACCOMPANYING DRAWINGS

To further clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in accordance with various embodiments of the invention, wherein:

FIG. 1 illustrates a method performed by a server to obtain an electronic informed consent from a patient/trial subject in accordance with an embodiment of present invention.

FIG. 2 illustrates a method performed by a server to obtain an electronic informed consent from a patient/trial subject in accordance with another embodiment of the present invention.

FIG. 3 illustrates a method performed by a client's device to obtain an electronic informed consent from a patient/trial subject in accordance with the embodiments of present invention.

FIG. 4 illustrates a method performed by a medical practitioner's device to obtain an electronic informed consent from a patient/trial subject in accordance with the embodiments of present invention.

FIG. 5 illustrates a method performed by a patient/trial subject's device to obtain an electronic informed consent from a patient/trial subject in accordance with the embodiments of present invention.

FIG. 6 illustrates a device, which can act as a client's device, a medical practitioner's device or a patient's/trial subject's device to obtain an electronic informed consent from a patient/trial subject in accordance with the embodiments of present invention.

FIG. 7 illustrates a server to obtain an electronic informed consent from a patient/trial subject in accordance with the embodiments of present invention.

FIG. 8 illustrates a system to obtain an electronic informed consent from a patient/trial subject in accordance with the embodiments of present invention.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims to follow in complete specification along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to claims to follow in the complete specification. The claims and their legal equivalents can be realized in the context of embodiments other than the ones used as illustrative examples in the description below.

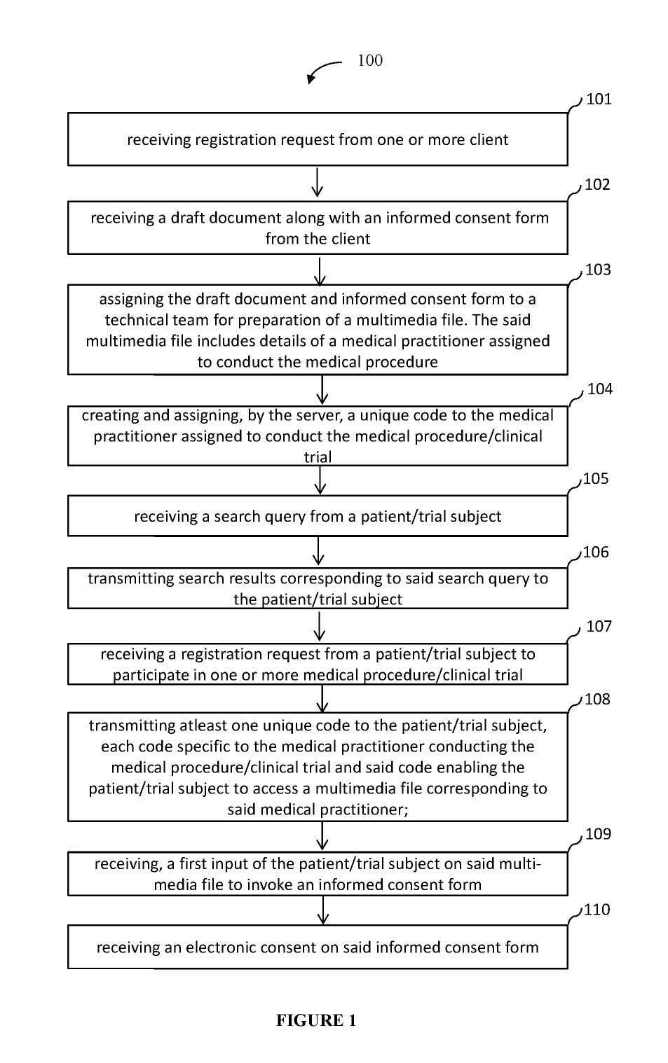

FIG. 1 illustrates a method 100 performed by a server to obtain an electronic informed consent from a patient/trial subject in accordance with an embodiment of present invention.

At step 101, the method comprises receiving a registration request from one or more client. The said request is received via a website/mobile application hosted by said server. The term “client” in the present invention includes pharmaceutical companies, governmental health agencies, researchers affiliated with a hospital or university medical program, independent researchers, or private industry or any combination thereof involved in conducting trials to evaluate the efficacy and safety of medicines, medical procedures and medical devices. The server, in response to the registration request, creates a login id and password for each medical practitioner.

At step 102, the method comprises receiving a draft document along with an informed consent form from the server. The draft document, along with the informed consent form, is uploaded by the client via said website/mobile application.

At step 103, the method comprises assigning the draft document and informed consent form to a technical team. The said technical team prepares dialogue transcripts for said draft document and informed consent form. The said dialogue transcripts are translated from a first language to one or more languages. The said translations are validated by back translating the above-mentioned documents from said one or more languages to the first language. The said documents are sent to the client for approval. On receiving the approval, the team prepares a multimedia file, which is further sent to the client for approval. The said multimedia file, on receiving approval from the client, is uploaded on the server.

The said multimedia file is an interactive file including animations and voice-overs to clearly explain the medical conditions, treatment options, risks involved and outcome of said medical procedures. Apart from details of medical procedure/clinical trial, said multimedia file includes one or more of: (i) details of site/location where the clinical trial/medical procedure is being conducted and duration of said clinical trial/medical procedure, (ii) details of a medical practitioner assigned to conduct the medical procedure/clinical trials, (iii) details of a central informed consent unit (CICU). The CICU unit has one or more qualified employees/medical representatives for resolution of patient/trial subject queries round the clock, (iv) selectable options for invoking communication with the medical practitioner, (v) selectable options for invoking communication with the CICU, (vi) selectable options such as “NEXT”, “BACK”, “PREVIOUS”, “PAUSE”, “RESTART” to navigate through the multimedia file, (vii) selectable options for invoking tests such as mental capacity test, a reading comprehension test and/or a content comprehension test to determine the understanding of patient in relation to the medical procedures/clinical trials, (viii) selectable options such as “I AGREE” or “INFORMED CONSENT FORM” for invoking an informed consent form, (ix) selectable options such as “WITHDRAW” for withdrawing from the medical procedure/clinical trials. The details including location of clinical trial, duration of clinical trial, medical practitioner assigned to conduct medical procedure/clinical trial corresponding to each medical procedure/clinical trial are also stored on the server.

At step 104, the method comprises creating and assigning a unique code to the medical practitioner assigned to conduct the medical procedure/clinical trial. The said unique code is transmitted to the medical practitioner. The medical practitioner can use the unique code to access said multimedia file.

At step 105, the method comprises receiving a search query from a patient/trial subject. The patient/trial subject enters the search query via the mobile application or the website hosted by said server. The search query may be in relation to one or more parameters including location of a clinical trial, duration of a clinical trial, medical condition/diseases on which clinical trials are conducted and medical practitioner conducting said trials.

At step 106, the method comprises transmitting search results corresponding to said search query (at step 105) to the patient/trial subject.

At step 107, the method comprises receiving a registration request from a patient/trial subject to participate in the medical procedure/clinical trial.

At step 108, the method comprises transmitting atleast one unique code to the patient trial subject, each code specific to the medical practitioner conducting the medical procedure/clinical trial, said code enabling the patient/trial subject to access a multimedia file corresponding to said medical practitioner

At step 109, the method comprises receiving a first input of the patient/trial subject on said multi-media file. The said first input corresponds to selection of options such as “I AGREE” or “INFORMED CONSENT FORM” in said multimedia file. On receiving said input, the server invokes an informed consent form for the patient/trial subject.

At step 110, receiving an electronic consent on said informed consent form. The electronic consent is received by means known in the art including video recording, audio recording, photo, digital signature, biometrics or any combination thereof. On completion of the consent process on the informed consent form, a copy of said consent form is transmitted only to the patient/trial subject and the medical practitioner to ensure the confidentiality of the patient/trial subject.

In one embodiment, the method comprises transmitting a list of patient/trial subjects (who have registered for the medical procedure/clinical trials) to the medical practitioner. The method further comprises receiving a selection of patient/trial subject from the medical practitioner and transmitting the unique code of the medical practitioner to the selected patients/trial subjects.

In another embodiment, the method comprises receiving a second input from the patient/trial subject on said multimedia file. The said second input corresponds to selection of options that invokes a communication channel between (i) the patient/trial subject and the medical practitioner, and/or (ii) the patient/trial subject and the medical representatives of central informed consent unit (CICU).

In yet another embodiment, the method comprises receiving a third input from the patient/trial subject on said multimedia file. The said third input corresponds to selection of withdrawal options such as “WITHDRAW” in said multimedia file. On receiving said input, the server allows patient/trial subject to withdraw from the medical procedures/clinical trial. The said option is available to the patient/trial subject at all stages of medical procedure/clinical trials i.e. before and after signing the informed consent form.

In yet another embodiment, the method comprises preparing a calendar to schedule/reschedule appointments of patient/trial subject and medical practitioner. The method further comprises transmitting, by a transmitting unit, alerts before each scheduled/rescheduled visit to the patient as well as medical practitioner. The said alerts may be transmitted by means known in the art including online chat, offline chat, video conferencing, messages, calls and any combination thereof.

In yet another embodiment, the method comprises blocking a further registration request from a patient/trial subject who has consented for another medical procedure/clinical trial. The said further registration request can be blocked for a pre-determined amount of time or after completion of said another medical procedure/clinical trial or after withdrawal of patient/trial subject from said another medical procedure/clinical trial.

In yet another embodiment, the method comprises receiving a final selection of patient/trial subject for conducting medical procedures/clinical trials. After the informed consent form is signed, the physician conducts screening tests on patients to find if the patient is eligible for clinical trials/medical procedures. Once the physician/investigator feels that patient can participate in a medical procedure/clinical trial, a final selection is made by him and transmitted to the server. The method further comprises assigning an enrolment number to selected patient/trial subject.

In yet another embodiment, the method comprises receiving and storing recordings/transcript of discussions between the medical representative of CICU and patient/trial subject. The method further comprises transmitting said recording to the medical practitioner/client for reference action.

In yet another embodiment, the method comprises presenting the patient/trial subject with one or more quizzes/tests/specific questions at different stages before and after the enrolment process to confirm the understanding/comprehension of the patient/trial subject in relation to treatment options, risks involved and outcomes of medical procedures/clinical trials.

In yet another embodiment, the method comprises repeating the complete process of approval and signing whenever there is any change, addition or removal of content/information from the informed consent document and/or informed consent form, Updated documents are assigned different versions.

In yet another embodiment, the method comprises maintaining an audit trail by recording all activities of patient and medical practitioner from “Log in” till “Log out”.

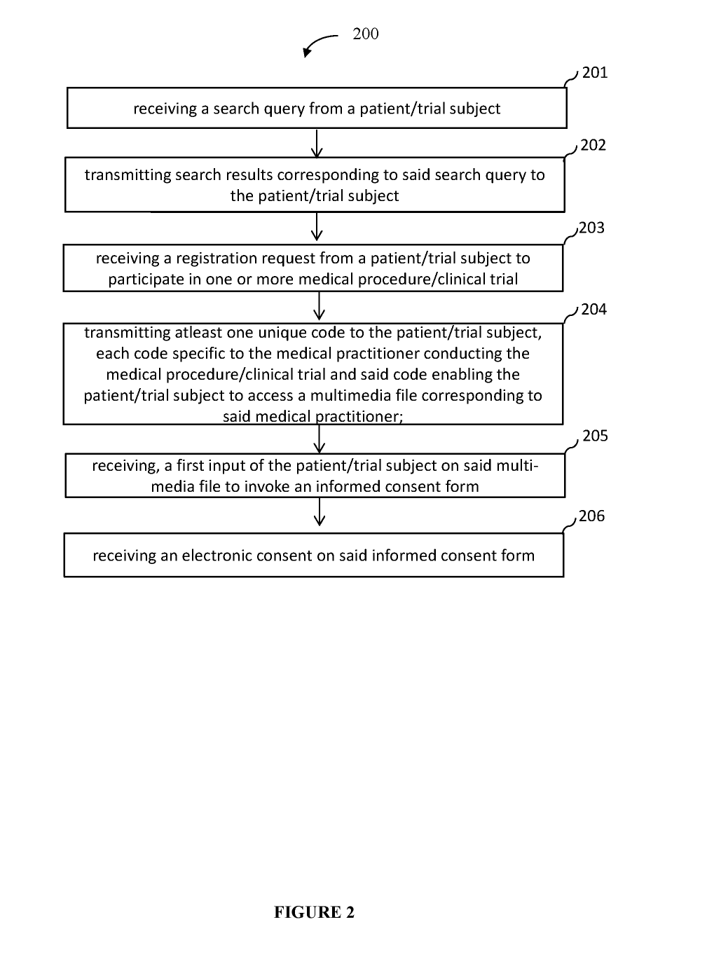

FIG. 2 illustrates a method performed by a server to obtain an electronic informed consent from a patient/trial subject in accordance with another embodiment of the present invention.

At step 201, the method comprises receiving a search query from a patient/trial subject. The patient/trial subject enters the search query via the mobile application or a website hosted by said server. The search query may be in relation to one or more parameters including location of a clinical trial, duration of a clinical trial, medical condition/diseases on which clinical trials are conducted and medical practitioner conducting said trials.

At step 202, the method comprises transmitting search results corresponding to said search query (at step 201) to the patient/trial subject.

At step 203, the method comprises receiving a registration request from the patient/trial subject to participate in atleast one medical procedure/clinical trial.

At step 204, the method comprises transmitting atleast one unique code to the patient trial subject, each code specific to the medical practitioner conducting the medical procedure/clinical trial, said code enabling the patient/trial subject to access a multimedia file corresponding to said medical practitioner. The said unique code is used by the patient/trial subject to access a multimedia file. The said multimedia file is an interactive file including animations and voice-overs to clearly explain the medical conditions, treatment options, risks involved and outcome of said medical procedures. Apart from details of medical procedure/clinical trial, said multimedia file includes one or more of: (i) details of site/location where the clinical trial/medical procedure is being conducted, (ii) contact details of a medical practitioner assigned to conduct the medical procedure/clinical trials, (iii) contact details of a central informed consent unit (CICU). The CICU unit has one or more qualified medical representatives for resolution of patient/trial subject queries round the clock, (iv) selectable options for invoking communication with the medical practitioner, (v) selectable options for invoking communication with the CICU, (vi) selectable options such as “NEXT”, “BACK”, “PREVIOUS”, “PAUSE”, “RESTART” to navigate through the multimedia file, (vii) selectable options for invoking tests such as mental capacity test, a reading comprehension test and/or a content comprehension test to determine the understanding of patient in relation to the medical procedures/clinical trials, (viii) selectable options such as “I AGREE” or “INFORMED CONSENT FORM” for invoking an informed consent form, (ix) selectable options such as “WITHDRAW” for withdrawing from the medical procedure/clinical trials.

At step 205, the method comprises receiving a first input from the patient/trial subject on said multi-media file. The said first input corresponds to selection of options such as “I AGREE” or “INFORMED CONSENT FORM” in said multimedia file. On receiving said first input, the server invokes an informed consent form for the patient/trial subject.

At step 206, the method comprises receiving an electronic consent on said informed consent form. The electronic consent is received by means known in the art including video recording, audio recording, photo, digital signature, biometrics or any combination thereof. On completion of the consent process on the informed consent form, a copy of said consent form is transmitted only to the patient/trial subject and the medical practitioner to ensure the confidentiality of the patient/trial subject.

In one embodiment, the method comprises creating and assigning a unique code to the medical practitioner assigned for conducting clinical trial/medical procedure.

In another embodiment, the method comprises transmitting a list of patient/trial subjects (who have registered for the medical procedure/clinical trials) to the medical practitioner. The method, thereafter, comprises receiving a selection of patient/trial subject from the medical practitioner and transmitting the unique code of the medical practitioner to the selected patients/trial subjects.

In another embodiment, the method comprises receiving a second input from the patient/trial subject on said multimedia file. The said second input corresponds to selection of options in the multimedia file that invokes a communication channel between (i) the patient/trial subject and the medical practitioner, and/or (ii) the patient/trial subject and the medical representatives of central informed consent unit (CICU).

In yet another embodiment, the method comprises receiving a third input from the patient/trial subject on said multimedia file. The said third input corresponds to selection of withdrawal options such as “WITHDRAW” in said multimedia file. On receiving said input, the patient/trial subject can withdraw from the medical procedures/clinical trial. The said option is available to the patient/trial subject before and after signing the informed consent form.

In yet another embodiment, the method comprises preparing a calendar to schedule/reschedule appointments of patient/trial subject and medical practitioner. The method further comprises transmitting, by a transmitting unit, alerts before each scheduled/rescheduled visit to the patient as well as medical practitioner. The said alerts may be transmitted by means known in the art including online chat, offline chat, video conferencing, messages, calls and any combination thereof.

In yet another embodiment, the method comprises blocking a further registration request from a patient trial subject who has consented for another medical procedure/clinical trial. The said further registration request can be blocked for a pre-determined amount of time or after completion of said another medical procedure/clinical trial or after withdrawal of patient/trial subject from said another medical procedure/clinical trial.

In yet another embodiment, the method comprises receiving a final selection of patient/trial subject for conducting medical procedures/clinical trials. After the electronic informed consent is signed, the physician conducts screening tests on patients to find if the patient is eligible for clinical trials/medical procedures. Once the physician/investigator feels that patient can participate in a medical procedure/clinical trial, a final selection is made by him and transmitted to the server. The method further comprises assigning an enrolment number to selected patient/trial subject.

In yet another embodiment, the method comprises receiving and storing recordings/transcript of discussions between the medical representative of CICU and patient/trial subject. The method further comprises transmitting said recording to the medical practitioner/client for reference action.

In yet another embodiment, the method comprises presenting the patient/trial subject with one or more quizzes/tests/specific questions at different stages before and after the enrolment process to confirm the understanding/comprehension of the patient/trial subject in relation to treatment options, risks involved and outcomes of medical procedures/clinical trials.

In yet another embodiment, the method comprises repeating the complete process of approval and signing whenever there is any change, addition or removal of content/information from the informed consent document and/or informed consent form, Updated documents are assigned different versions.

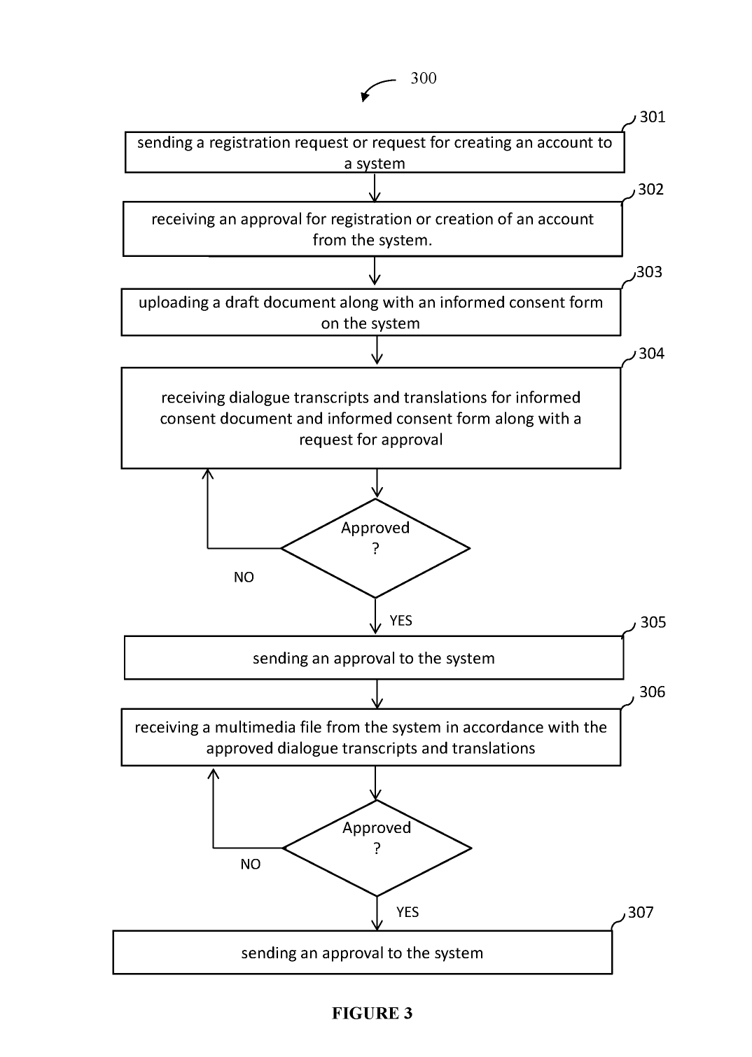

FIG. 3 illustrates a method performed by a client's device to obtain an electronic informed consent from a patient/trial subject in accordance with the embodiments of present invention.

As already stated, the term “client” in the present invention includes pharmaceutical companies, governmental health agencies, researchers affiliated with a hospital or university medical program, independent researchers, or private industry or any combination thereof involved in conducting trials to evaluate the efficacy and safety of medicines, medical procedures and medical devices.

At step 301, the method comprises sending a registration request or request for creating an account to a server. The said request is sent via a website or a downloaded mobile application hosted by said server.

At step 302, the method comprises receiving an approval for registration or creation of an account from the server.

At step 303, the method comprises uploading a draft document along with an informed consent form on the server. The draft document includes (i) details of the medical procedure/clinical trial, (ii) details of location/site at which a clinical trial/medical procedure is to be conducted and (iii) details of medical practitioner assigned to said location/site.

At step 304, the method comprises receiving dialogue transcripts and translations for informed consent document and informed consent form along with a request for approval.

At step 305, the method comprises sending an approval to the server if the dialogue transcripts and translations for informed consent document and informed consent form are in order. In case, the same are not in order, a request for necessary changes to the documents is sent to the server and method resumes from step 304.

At step 306, the method comprises receiving a multimedia file from the server in accordance with the approved dialogue transcripts and translations. The said multimedia file is an interactive file including animations and voice-overs to clearly explain the medical conditions, treatment options, risks involved and outcome of said medical procedures. Apart from details of medical procedure/clinical trial, said multimedia file includes one or more of: (i) details of site/location where the clinical trial/medical procedure is being conducted, (ii) contact details of a medical practitioner assigned to conduct the medical procedure/clinical trials, (iii) contact details of a central informed consent unit (CICU). The CICU unit has one or more qualified medical representatives for resolution of patient/trial subject queries round the clock, (iv) selectable options for invoking communication with the medical practitioner, (v) selectable options for invoking communication with the CICU, (vi) selectable options such as “NEXT”, “BACK”, “PREVIOUS”, “PAUSE”, “RESTART” to navigate through the multimedia file, (vii) selectable options for invoking tests such as mental capacity test, a reading comprehension test and/or a content comprehension test to determine the understanding of patient in relation to the medical procedures/clinical trials, (viii) selectable options such as “I AGREE” or “INFORMED CONSENT FORM” for invoking an informed consent form, (ix) selectable options such as “WITHDRAW” for withdrawing from the medical procedure/clinical trials.

At step 307, sending an approval if multimedia file is in order. In case, the same is not in order, a request for necessary changes to the documents is sent to the server.

In one embodiment, the method comprises receiving, by the client's device, recordings/transcript of discussions between the medical representative of CICU and patient/trial subject. The said recordings are used by the client for records.

In another embodiment, the method comprises receiving, by the client's device, any change/update in the informed consent form/multimedia file/draft document. Whenever there is any change, addition or removal of content/information from the informed consent document, multimedia file and/or informed consent form, the complete process of approval and signing will be repeated. Updated documents are assigned different versions.

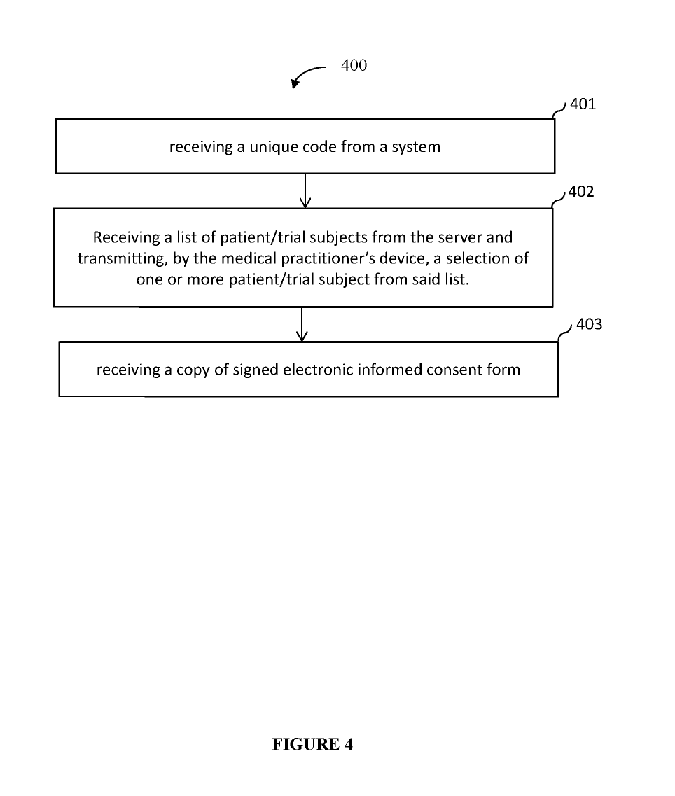

FIG. 4 illustrates a method performed by a medical practitioner's device to obtain an electronic informed consent from a patient/trial subject in accordance with the embodiments of present invention.

At step 401, the method comprises receiving, by a medical practitioner's device, a unique code from a server. The said unique code is used by the medical practitioner to access a multimedia file and communicate with the patient/trial subject.

At step 402, the method comprises receiving, by the medical practitioner's device, a list of patient/trial subjects from the server and transmitting, by the medical practitioner's device, a selection of one or more patient/trial subject from said list.

At step 403, the method comprises receiving, by the medical practitioner's device, a copy of signed informed consent form.

In one embodiment, the method comprises receiving, by the medical practitioner's device, a request to communicate with the patient/trial subject.

In another embodiment, the method comprises receiving, by the medical practitioner's device, a request from the patient/trial subject to withdraw from said medical procedure/clinical trial.

In another embodiment, the method comprises sending/receiving, by the medical practitioner's device, a request from the patient/trial subject to schedule/reschedule appointments.

In another embodiment, the method comprises receiving by the medical practitioner's device, a list of patient/trial subject for final selections of patient/trials subjects. After the electronic informed consent is signed, the medical practitioner conducts screening tests on patients to find if the patient is eligible for clinical trials/medical procedures. Once the physician/investigator feels that patient can participate in a medical procedure/clinical trial, a final selection is made by him and transmitted to the server.

In another embodiment, the method comprises receiving, by the medical practitioner's device, recordings/transcript of discussions between the medical representative of CICU and patient/trial subject. The said recordings are used by the medical practitioner for reference action.

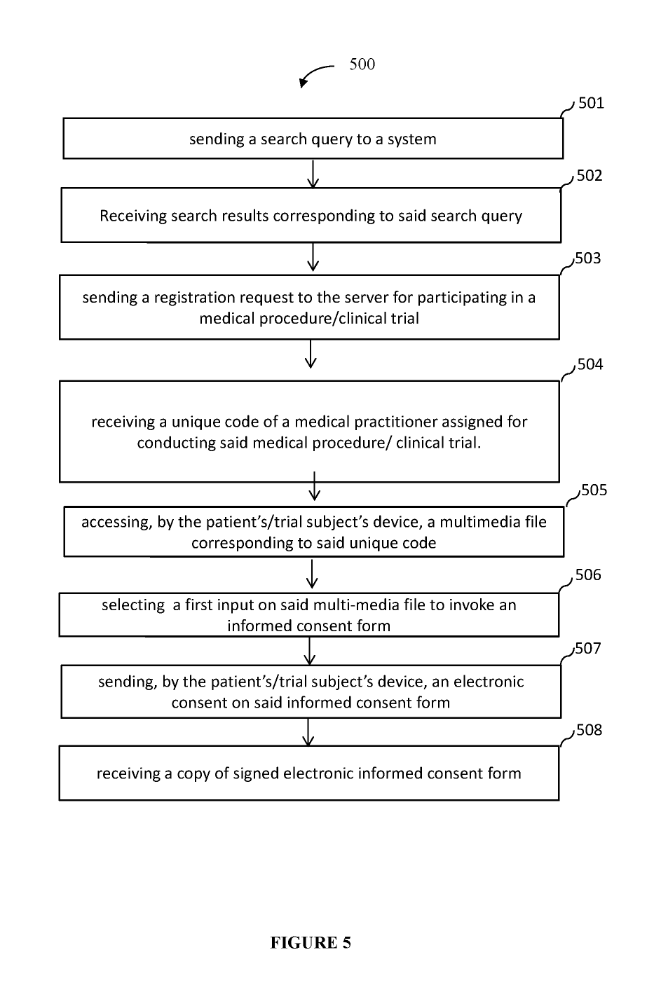

FIG. 5 illustrates a method performed by a patient/trial subject's device to obtain an electronic informed consent from a patient/trial subject in accordance with the embodiments of present invention.

At step 501, the method comprises sending, by the patient's/trial subject's device, a search query to a server. The patient trial subject enters the search query via a mobile application or a website hosted by said server. The search query may be in relation to one or more parameters including location of a clinical trial, duration of a clinical trial, medical condition/diseases and medical practitioner conducting trials.

At step 502, the method comprises receiving, by the patient's/trial subject's device, search results corresponding to said search query. For example, the patient/trial subject may submit a search query in relation to location of clinical trials. The server processes the search query and transmits search results in relation to different locations at which the clinical trials are being conducted.

At step 503, the method comprises sending, by the patient's/trial subject's device, a registration request to the server for participating in a medical procedure/clinical trial.

At step 504, the method comprises receiving, by the patient's/trial subject's device, a unique code of a medical practitioner assigned for conducting said medical procedure/clinical trial.

At step 505, the method comprises accessing, by the patient's/trial subject's device, a multimedia file corresponding to said unique code.

At step 506, the method comprises selecting a first input on said multi-media file. The said first input corresponds to selection of options such as “I AGREE” or “INFORMED CONSENT FORM” in said multimedia file. On receiving said input, the server invokes an informed consent form for the patient/trial subject.

At step 507, the method comprises sending, by the patient's/trial subject's device, an electronic consent on said informed consent form. The electronic consent is sent by means including video recording, audio recording, photo, digital signature, biometrics or any combination thereof.

At step 508, the method comprises receiving, by the patient/trial subject's device, a copy of signed informed consent form.

In one embodiment, the method comprises providing, by the patient's/trial subject's device, a second input on said multimedia file. The said second input corresponds to selection of options that invokes a communication channel between (i) the patient/trial subject and the medical practitioner, and/or (ii) the patient/trial subject and the medical representatives of central informed consent unit (CICU).

In another embodiment, the method comprises providing, by the patient's/trial subject's device, a third input on said multimedia file. The said third input corresponds to selection of withdrawal options such as “WITHDRAW” in said multimedia file. On receiving said input, the patient/trial subject can withdraw from the medical procedures/clinical trial. The said option is available to the patient/trial subject before and after signing the informed consent form.

In another embodiment, the method comprises selecting, by the patient/trial subject's device, a selectable option on a multimedia file to invoke communication channel with the medical practitioner.

In another embodiment, the method comprises selecting by the patient/trial subject's device, an option on a multimedia file to schedule/reschedule appointments with medical practitioner.

In another embodiment, the method comprises receiving, by the patient/trial subject's device, alerts in relation to appointments with the medical practitioner.

In another embodiment, the method comprises selecting, by the patient's/trial subject's device, a selectable option on said multimedia file to invoke one or more quizzes/tests/specific questions at different stages i.e. before and after the enrolment process.

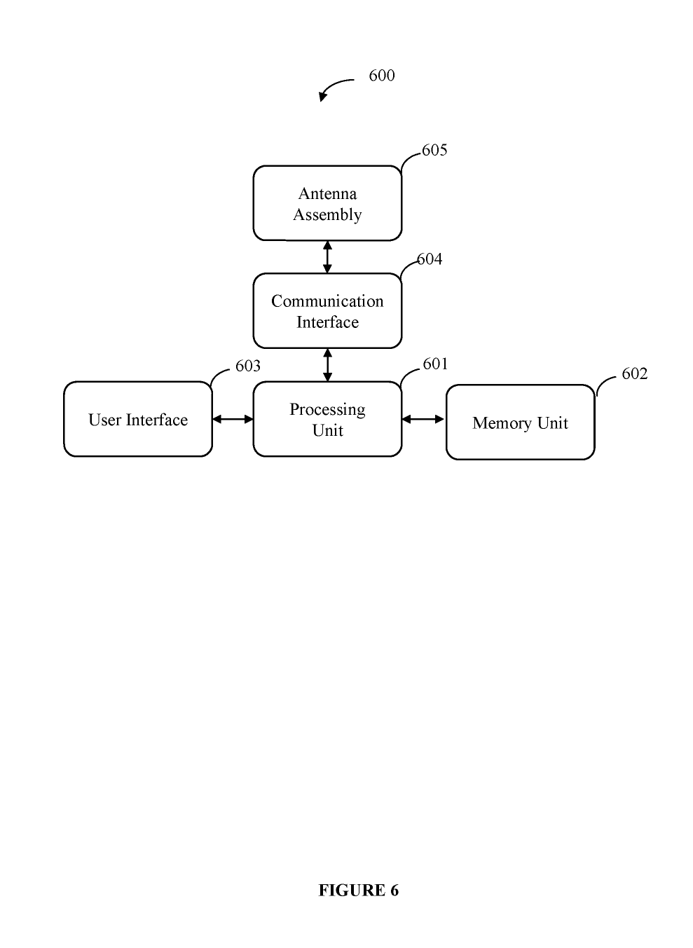

FIG. 6 illustrates a device 600, which can act as a client's device, a medical practitioner's device or a patient's/trial subject's device to obtain an electronic informed consent from a patient/trial subject in accordance with the embodiments of present invention.

The said device 600 may include one or more of a processing unit 601, a memory unit 602, a user interface 603 and a communication interface 604. The said device may further comprise an antenna assembly 605. The processing unit 601 may include one or more processors, microprocessors, application specific integrated circuits (ASICs), field programmable gate arrays (FPGAs), or the like. The processing unit 601 may control the operation of the said device 600 and its components.

The memory unit 602 may include a random access memory (RAM), a read only memory (ROM), and/or other type of memory to store data and instructions that may be used by the processing unit 601. The memory unit 602 includes an application. More specifically, the application may be a pre-installed application or may be downloaded from a server hosting such an external application.

The user interface 603 may include mechanisms for inputting information to the device 600 and/or for outputting information from the device 600. Examples of input and output mechanisms might include a speaker to receive electrical signals and output audio signals; a camera lens to receive image and/or video signals and output electrical signals; a microphone to receive audio signals and output electrical signals; buttons (e.g., control buttons and/or keys of a keypad) to permit data and control commands to be input into the device 600; a display to output visual information; a light emitting diode; a vibrator to cause the device 600 to vibrate etc.

The communication interface 604 may include any transceiver-like mechanism that enables the device 600 to communicate with other devices and/or systems. For example, the communication interface 604 may include a modem or an Ethernet interface to a LAN. The communication interface 604 may also include mechanisms for communicating via a network, such as a wireless network. For example, the communication interface 604 may include a transmitter that may convert baseband signals from the processing unit 601 to radio frequency (RF) signals and/or a receiver that may convert RF signals to baseband signals. Alternatively, the communication interface 604 may include a transceiver to perform functions of both a transmitter and a receiver.

The antenna assembly 605 may include one or more antennas to transmit and/or receive RF signals over the air. The antenna assembly 605 may, for example, receive RF signals from the communication interface 604 and transmit them over the air and receive RF signals over the air and provide them to the communication interface 604. In one implementation, for example, the communication interface 604 may communicate with new generation cellular network, older generation cellular network, and/or with one or more other cellular networks.

The device 600 may perform certain operations. The device 600 may perform these operations in response to the processing unit 601 executing software instructions contained in a computer-readable medium, such as the memory unit 602. A computer-readable medium may be defined as a non-transitory memory device. A memory device may include spaces within a single physical memory device or spread across multiple physical memory devices. The software instructions may be read into the memory unit 602 from another computer-readable medium or from another device via the communication interface 604. The software instructions contained in the memory unit 602 may cause the processing unit 601 to perform processes described herein. Alternatively, hardwired circuitry may be used in place of or in combination with software instructions to implement processes described herein. Thus, implementations described herein are not limited to any specific combination of hardware circuitry and software.

Although FIG. 6 shows a number of components of the device 600, in other implementations, the device 600 may include fewer components, different components, differently arranged components, or additional components than depicted in said FIG. 6. Additionally or alternatively, one or more components of the device 600 may perform the tasks described as being performed by one or more other components of the device 600.

Examples of device 600 includes a personal computer (PC), a tablet PC, a personal digital assistant (PDA), a mobile device, a palmtop computer, a laptop computer, a desktop computer, a communications device or any other machine capable of executing a set of instructions (sequential or otherwise) that specify actions to be taken by that machine.

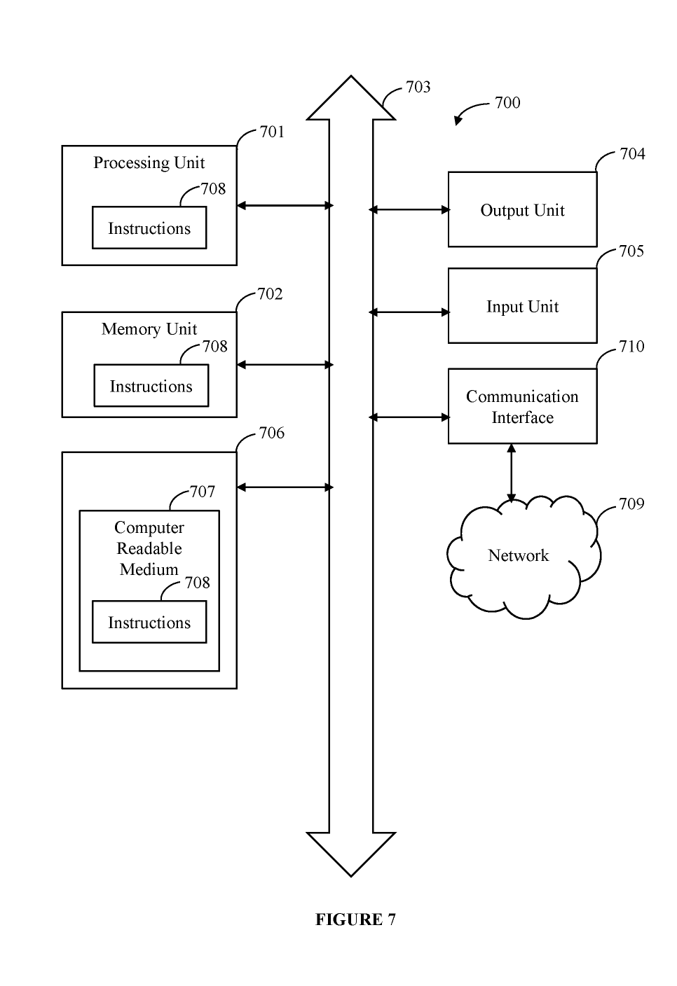

FIG. 7 illustrates a server for obtaining an informed consent from a patient/trial subject, in accordance with one or more embodiments of the invention. In one preferred implementation, the server 700 may be a network operator independent server 700 that can perform the method 100 and 200 described in conjunction with FIG. 1 and FIG. 2. In an alternative implementation, the server 700 may be deployed in operator premises to serve the subscribers of the network operator without requiring any trigger from the network operator. In another implementation, the server 700 may be implemented as a distributed system, wherein a network operator independent component interacts with a component deployed in operator premises to exchange cross operator information. The server 700 may be an application server hosting an application 703 for obtaining informed consent from a patient trial subject. In one specific implementation, the server 700 may be implemented as a cloud based solution.

The server 700 can include a set of instructions that can be executed to cause the server 700 to perform any one or more of the methods disclosed. The server 700 may operate as a standalone device or may be connected, for example, using a network to other computing systems or peripheral devices.

In a networked deployment, the server 700 may operate as a client user computer in a server-client user network environment, or as a peer-to-peer (or distributed) network environment. The server 700 can also be implemented as or incorporated into various devices, such as a personal computer (PC), a tablet PC, a personal digital assistant (PDA), a mobile device, a palmtop computer, a laptop computer, a desktop computer, a communications device or any other machine capable of executing a set of instructions (sequential or otherwise) that specify actions to be taken by that machine. Further, while a single server 700 is illustrated, the term “server” shall also be taken to include any collection of servers or sub-servers that individually or jointly execute a set, or multiple sets, of instructions to perform one or more computer functions.

The server 700 may include a processing unit 701 e.g., a central processing unit (CPU), a graphics processing unit (GPU), or both. The processing unit 701 may be a component in a variety of systems. For example, the processing unit 701 may be part of a standard personal computer or a workstation. The processing unit 701 may be one or more general processors, digital signal processors, application specific integrated circuits, field programmable gate arrays, servers, networks, digital circuits, analog circuits, combinations thereof, or other now known or later developed devices for analysing and processing data. The processing unit 701 may implement a software program, such as code generated manually (i.e., programmed).

The server 700 may include a memory unit 702, such as a memory unit 702 that can communicate via a bus 703. The memory unit 702 may be a main memory, a static memory, or a dynamic memory. The memory unit 702 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory unit 702 includes a cache or random access memory for the processing unit 701. In alternative examples, the memory unit 702 is separate from the processing unit 701, such as a cache memory of a processor, the system memory, or other memory. The memory unit 702 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory unit 702 is operable to store instructions executable by the processing unit 701. The functions, acts or tasks illustrated in the figures or described may be performed by the programmed processing unit 701 executing the instructions stored in the memory unit 702. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the server 700 may or may not further include an output unit 704, such as an audio unit and/or a display unit. The examples of the display unit include, but are not limited to a liquid crystal display (LCD), an organic light emitting diode (OLED), a flat panel display, a solid state display, a cathode ray tube (CRT), a projector, a printer or other now known or later developed display device for outputting determined information. The output unit 704 may act as an interface for the user to listen/see the functioning of the processing unit 701, or specifically as an interface with the software stored in the memory unit 702 or in a removable storage device.

Additionally, the server 700 may include an input unit 705 configured to allow a user to interact with any of the components of server 700. The input unit 705 may be a number pad, a keyboard, or a cursor control device, such as a mouse, or a joystick, touch screen display, remote control or any other device operative to interact with the server 700.

The server 700 may also include a disk or optical drive unit 706. The disk drive unit 706 may include a computer-readable medium 707 in which one or more sets of instructions 708, e.g. software, can be embedded. Further, the instructions 708 may embody one or more of the methods or logic as described. In a particular example, the instructions 708 may reside completely, or at least partially, within the memory unit 702 or within the processing unit 701 during execution by the server 700. The memory unit 702 and the processing unit 701 also may include computer-readable media as discussed above.

The present invention contemplates a computer-readable medium that includes instructions 708 or receives and executes instructions 708 responsive to a propagated signal so that a device connected to a network 709 can communicate voice, video, audio, images or any other data over the network 709. Further, the instructions 708 may be transmitted or received over the network 709 via a communication port or interface 710 or using the bus 703. The communication port or interface 710 may be a part of the processing unit 701 or may be a separate component. The communication port or interface 710 may be created in software or may be a physical connection in hardware. The communication port or interface 710 may be configured to connect with the network 709, external media, the output unit 704, or any other components in the server 700 or combinations thereof. The connection with the network 709 may be a physical connection, such as a wired Ethernet connection or may be established wirelessly as discussed later. Likewise, the additional connections with other components of the server 700 may be physical connections or may be established wirelessly. The network 709 may alternatively be directly connected to the bus 703.

The network 709 may include wired networks, wireless networks, Ethernet AVB networks, or combinations thereof. The wireless network may be a cellular telephone network, an 802.11, 802.16, 802.20, 802.1Q or WiMax network. Further, the network 709 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the server 700.

The present invention can be implemented on a variety of electronic and computing systems. For instance, one or more examples described may implement functions using two or more specific interconnected hardware modules or devices with related control and data signals that can be communicated between and through the modules, or as portions of an application-specific integrated circuit. Accordingly, the present server encompasses software, firmware, and hardware implementations.

Any one or more of the methods or logic as described may be implemented in part by software programs executable by a server. Further, in a non-limited example, implementations can include distributed processing, component/object distributed processing, and parallel processing. Alternatively, virtual server processing can be constructed to implement various parts of the server 700.

The server 700 is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

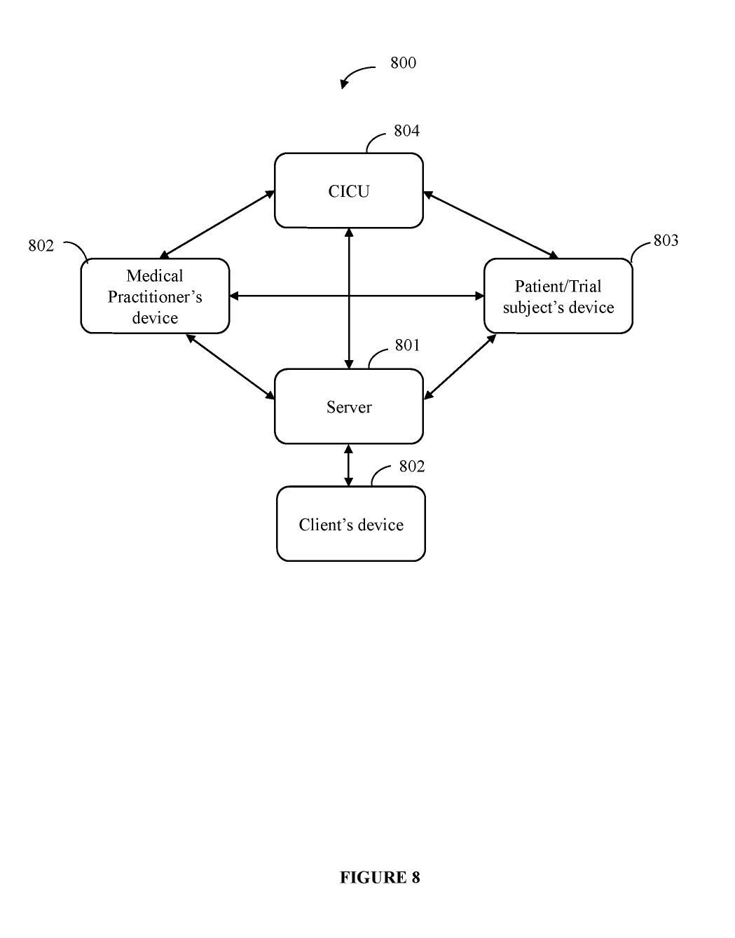

FIG. 8 illustrates a system 800 to obtain an electronic informed consent from a patient/trial subject in accordance with the embodiments of present invention.

The said system comprises atleast one server 801, atleast one medical practitioner's device 802, atleast one patient's/trial subject's device 803, atleast one client's device 804 and a central informed consent unit (CICU) 805.

The said server 801 is configured for communicating with the medical practitioner's device 802, the patient's/trial subject's device 803, the client's device 804 and the central informed consent unit 805.

The said medical practitioner's device 802 is configured for communicating with the server 801, the patient's/trial subject's device 803 and the central informed consent unit 805.

The said patient/trial subject's device 803 is configured for communicating with the server 803, the medical practitioner's device 802 and the central informed consent unit 805.

The CICU is configured for communicating with the server 801, the medical practitioner's device 802 and patient's/trial subject's device 803.

The client's device 804 is configured for communicating with the server. The client's device is also capable of communicating with the medical practitioner's device or patient/trial subject's device.

The said devices 801, 802, 803, 804 and 805 are capable of communicating via a circuit communication mode or a data communication mode. The data communication mode sends data over Internet Protocol (IP) network.

While certain present preferred embodiments of the invention have been illustrated and described herein, it is to be understood that the invention is not limited thereto. Clearly, the invention may be otherwise variously embodied, and practiced within the scope of the claims to follow in complete specification.

We claim:

1. A method for obtaining an electronic informed consent from a patient/trial subject for a medical procedure/clinical trial recruitment, said method comprising:
receiving a search query from the patient/trial subject;
transmitting a search result to the patient/trial subject in response to said search query;
receiving a registration request from the patient/trial subject to participate in one or more medical procedure/clinical trial;
transmitting atleast one unique code to the patient/trial subject, each code specific to the medical practitioner conducting the medical procedure/clinical trial and said code enabling the patient/trial subject to access a multimedia file corresponding to said medical practitioner;
receiving a first input on said multi-media file;
invoking an informed consent form in response to receipt of said first input; and
receiving an electronic consent on the informed consent form.

2. The method as claimed in claim 1, wherein the search query relates to one or more of: clinical trials, location of the clinical trial, duration of the clinical trial and list of medical practitioners conducting the clinical trial.

3. The method as claimed in claim 1, further comprising the step of:
receiving a second input on said multimedia file; and
invoking a communication channel on receipt of said second input.

4. The method as claimed in claim 3, wherein said communication channel includes one or more: online chat, offline chats, video conferencing, messages and calls.

5. The method as claimed in claim 3, wherein said communication channel provides for communication between the patient/trial subject and the medical practitioner.

6. The method as claimed in claim 3, wherein said communication channel provides for communication between the patient/trial subject and a central informed consent unit.

7. The method as claimed in claim 1, wherein multimedia files comprises one or more:
details of the medical procedure;
details of medical practitioner assigned to the medical procedure/clinical trial;
details of a location/site;
options for invoking an informed consent form;
options for navigating through the multimedia file;
options for invoking a communication channel;
options for withdrawal from the medical procedure/clinical trial;
a mental capacity test;
a reading comprehension test; and
a content comprehension test.

8. The method as claimed in claim 1 wherein the electronic consent is received by one or more:
video recording;
audio recording;
photo;
digital signature; and
biometrics

9. The method as claimed in claim 1, further comprising:
Receiving a third input on said multi-media file; and
invoking a withdrawal process on receipt of said third input.

10. The method as claimed in claim 1, further comprising the step of:
preparing a calendar to schedule/re-schedule appointments/visits of patient/trial subject and medical practitioner; and
transmitting alerts before said each scheduled/rescheduled visit.

11. The method as claimed in claim 10, wherein alerts are transmitted via one or more: online chat, offline chats, video conferencing, messages and calls.

12. The method as claimed in claim 1, further comprising the steps of:
blocking receipt of a further registration request by a patient/trial subject

13. A server for obtaining electronic informed consent from a patient/trial subject for a medical procedure/clinical trial recruitment, said server comprising:
a user interface unit configured for:
receiving a search query from a patient/trial subject;
transmitting a search result to the patient/trial subject in response to said search query;
receiving a registration request from a patient/trial subject to participate in one or more medical procedure/clinical trial;
transmitting atleast one unique code to the patient/trial subject, each code specific to the medical practitioner conducting the medical procedure/clinical trial and said code enabling the patient/trial subject to access a multimedia file corresponding to said medical practitioner;
receiving a first input on the multimedia file; and
receiving an electronic consent on an informed consent form,
a processing unit configured for:
creating a unique code for the medical practitioner assigned for conducting said clinical trial/medical procedures; and
invoking an electronic consent form in response to receipt of said first input.

14. The server as claimed in claim 13, wherein the processing unit is further configured for invoking a communication channel on receipt of a second input on said multimedia file.

15. The server as claimed in claim 14, wherein said communication channel is provided for communication between (i) the patient/trial subject and the medical practitioner and/or (ii) the patient/trial subject and a central informed consent unit (CICU).

16. The server as claimed in claim 14, wherein said communication channel includes one or more: online chat, offline chats, video conferencing, messages and calls.

17. The server as claimed in claim 13, wherein the processing unit is further configured for invoking a withdrawal process on receipt of a third input.

18. The server as claimed in claim 13, wherein the processing unit is further configured for scheduling/re-scheduling appointments/visits of patient/trial subject and medical practitioner.

19. The server as claimed in claim 13, wherein the user interface unit is further configured for transmitting alerts before each scheduled/rescheduled visit of the patient/trial subject and the medical practitioner.

20. The server as claimed in claim 19 wherein alerts are transmitted via one or more: online chat, offline chats, video conferencing, messages and calls.

21. The server as claimed in claim 13 wherein the processing unit is further configured for blocking receipt of a further registration request by a patient/trial subject.
